(19) United States
(12) Patent Application Publication
(10) Pub. No.: US 2007/0272565 A1
(43) Pub. Date: Nov. 29, 2007

(54) Casing for an electronic key

(76) Inventors: Edvard Rueckert, Velbert (DE); Thorsten Janssen, Velbert (DE); Andreas Nickel, Sprockhoevel (DE)

Correspondence Address: ST. ONGE STEWARD JOHNSTON & REENS, LLC, 986 BEDFORD STREET, STAMFORD, CT, 06905-5619, US

(21) Appl. No.: 11/684,297

(22) Filed: Mar. 9, 2007

(30) Foreign Application Priority Data
Mar. 9, 2006 (DE) 10 2006 010 896.5

(51) Int. Cl. E05B 19/00

(52) U.S. Cl. 206/37.1

(57) ABSTRACT

The invention relates to a casing for a key with sensors that are positioned inside the casing and that are actuated by means of push buttons, so that the push buttons are situated in openings of a casing cover and can be displaced against a rebound force perpendicularly to the surface of the casing cover in the direction toward the sensors. In order to improve a generic casing both in terms of production technology as well as in advantageous uses, it is proposed that the push buttons made of a hard plastic are inserted with lateral distance in the openings and are held in place by a soft plastic inset inserted into a recess in the casing cover.

### CROSS-REFERENCE TO RELATED APPLICATIONS

The present application claims priority of German patent application No. 10 2006 010 896.5 filed on Mar. 9, 2006, the content of which is incorporated herein by reference.

### FIELD OF THE INVENTION

The invention relates to a casing for a key with sensors that are positioned inside the casing and that are actuated by means of push buttons, so that the push buttons are situated in openings of a casing and can be displaced against a rebound force perpendicularly to the surface of the casing in the direction toward the sensors.

### BACKGROUND OF THE INVENTION

A generic casing is known in the art from DE 43 07 909 A1. This publication describes the casing for an electronic key, such that a keyboard is situated in the casing cover. The keyboard consists of several keys, which can be moved perpendicularly to the surface of the casing cover. These keys configured as push buttons can actuate sensors positioned under the keys.

Also known from DE 199 64 166 C1 is a casing for an electronic key. In the casing is a circuit board on which several sensors are positioned. Above the sensors is a push button, which includes plungers on its underside. These plungers extend through the openings in a recess in the upper side of the casing cover. The push buttons can be moved against the back pressure by spring elements on the sensors.

Likewise, DE 202 21 045 C2 describes a casing for an electronic key consisting of two covers. Here too a board is situated approximately in the divider level of the two casing covers; said board carries a number of sensors. Above the sensors are found push buttons that include plungers and can be actuated from the outside. The push buttons are made of a soft plastic insert.

### SUMMARY OF THE INVENTION

It is the aim of the invention to improve the generic casing both in terms of production technology and of operating advantages.

This aim is fulfilled by means of the invention described in the Claims, where each Claim constitutes an individual solution to the aim.

It is first provided, essentially, that the push buttons are made of a hard plastic. These push buttons are situated with a lateral distance in the openings of the cover. They are held in these positions by a soft plastic inset. A single soft plastic inset can be placed in a recess in the cover and thus can configure the keyboard. The soft plastic inset constitutes the spring element, with which the push buttons can be moved back again from their position, which actuates the keys. At the same time the soft plastic inset forms an insulation against the outside, so that the electronic switch found inside the casing is protected at least from splashing water. On their underside the push buttons each have plungers, with which they can act on the sensor. Each push button lies in an opening in the floor of a recess, in which the soft plastic inset is inserted. The number of openings thus corresponds to the number of push buttons. As a result of the distance that separates the push buttons from the wall of the opening, the soft plastic inset has a deflection zone, which permits the movement of the push button. The push buttons are situated in the openings with a distance from the wall on all sides. On their side facing away from the plungers, the push buttons have light signal profiles. With these light signal profiles the push buttons are anchored in the soft plastic inset. The soft plastic inset can consist of a dark plastic. The push buttons can be made of a bright plastic, or vice versa. The surfaces of the light signal profiles are flush with the outer surface of the soft plastic inset, so that the light signal profiles serve not only to anchor the push buttons in the soft plastic inset. The light signal profiles, in addition, form recognizable symbols. For this purpose it is advantageous if a color contrast exists between the color of the soft plastic inset and the color of the push buttons. Push buttons of diverse colors may also be used in order to constitute symbols of various colors. The height of the light signal profile corresponds to the material strength of the soft plastic inset.

The previously described key casings are preferably manufactured in an injection moulding tool. Thus, for instance, the casing is produced in a first injection moulding step. The entire process takes place in a common injection moulding form. The push buttons can also be manufactured before the production of the casing body. They are injected into the cavity at a distance from one another. The push buttons can also be produced in several steps, if variously colored pressure pieces are to be formed. The material of the push buttons is a hard plastic. The casing is injected with a distance around the push buttons, so that the push buttons remain in their shape. For this purpose it proves advantages if the push buttons possess plungers pointing downward, because they are thus anchored in the form. In a final injection moulding step, a soft plastic inset is injected into the opening of the upper side of the casing. This occurs when the cover is not hardened, so that the plastic of the soft plastic inset can be joined with the plastic of the cover for insulation without the help of adhesion agents. The push buttons are anchored in the plastic inset with their light signal profiles, which are surrounded with injection from the plastic inset.

One embodiment of the invention is described hereafter with reference to appended illustrations.

### BRIEF DESCRIPTION OF THE DRAWINGS

FIG. 1 shows an overhead view of a key.

FIG. 2 shows die side view of a cover of a key casing for a key as in FIG. 1.

FIG. 3 shows a section along the line III-III in FIG. 1.

FIG. 4 shows an explosion view of the individual elements of the cover.

### DETAILED DESCRIPTION OF THE INVENTION

The key shown in FIG. Has a casing whose cover 1 is visible. The casing bears a key shaft 3. On the broad side of the cover 1 is found a keyboard 2 with a total of five keys.

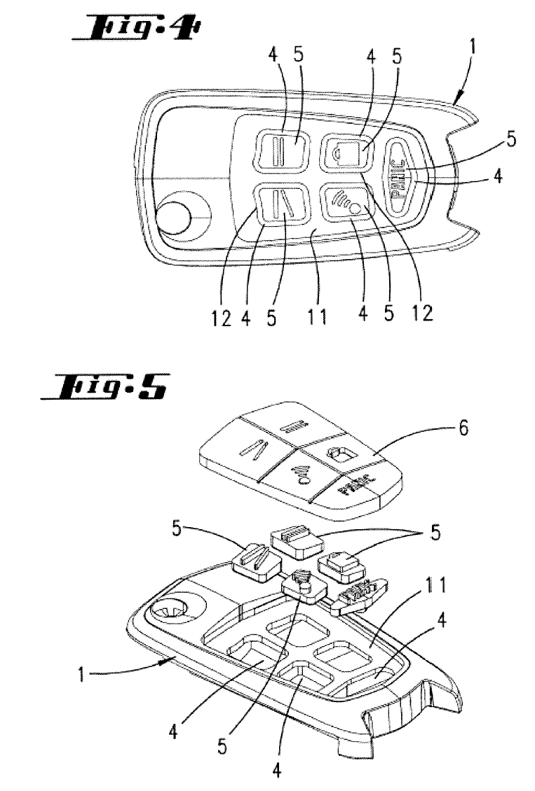

As can be recognized from FIGS. 3 and 4, the cover 1 has a number of openings 4, which are positioned inside a recess 11. The openings are arranged in a cross-bar pattern, so that each opening 4 comprises a frame.

In each opening 4 sits a push button 5. The push button 5 consists of a hard plastic material. The color of the plastic can be selected at will. The plastic can also be transparent in order, for instance, to convey the light of a light diode toward the outside.

The push buttons 5 sit in the openings 4 with a distance 12 surrounding them on all sides. From the underside of the push buttons 5, plungers 9 extend downward. With these plungers 9, electric sensors 8 can be actuated, which are located on a conductor plate 7 in the casing. A sender-and-receiver device can be actuated by the sensors 4 in order to send electrical signals to a lock of a motor vehicle or the like by means of the remote key.

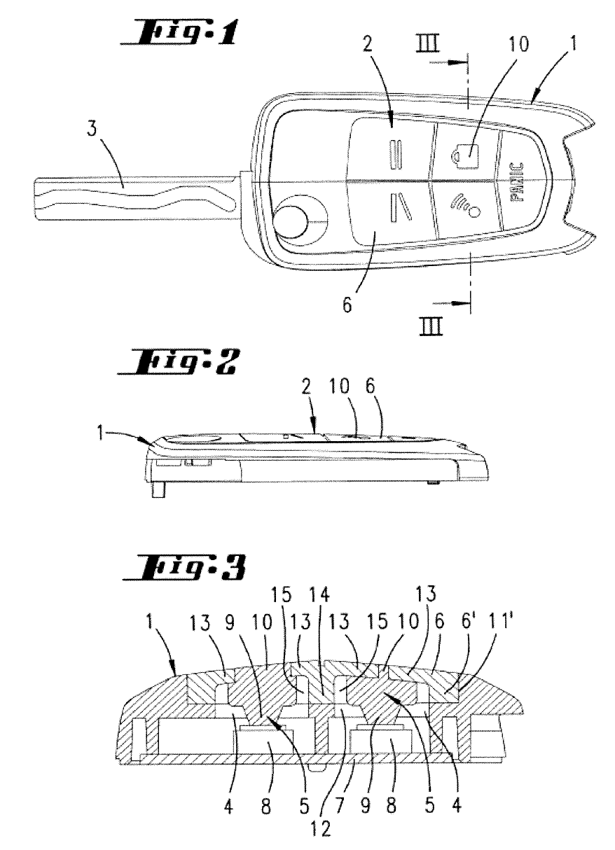

The push buttons 5 have variously configured light signal profiles 10 on the side opposite the plungers 9. The design of the light signal profiles can be seen in FIG. 1. The light signal profiles 10 constitute not just distinguishing symbols for the individual keys of the keyboard 2. They also serve to anchor the push buttons 5 inside a soft plastic inset 6, with which the recess 11 of the cover 1 is filled. The material strength of the soft plastic inset 6 thus corresponds to the height of the light signal profiles 10, so that the surface of the front side of each light signal profile 10 is flush with the broad side surface of the soft plastic inset 6.

The soft plastic inset constitutes the spring element with which the push buttons 5, moved rightward to the surface level of the cover 1, are returned into the starting position again. The area of the soft plastic inset 6, which spans the distance area between the frame and the push button 5, constitutes a deflection zone 13, which provides the required elastic rebound force.

As can be seen from FIG. 3, the material strength of the soft plastic inset is reinforced in the area surrounding the openings 4. In particular in the area of the border 6′, the material strength is greater. The soft plastic inset 6 thus constitutes troughs formed by studs 14 or the border 6′, in which the push buttons are inserted. The outline contour of these troughs 15 corresponds to the outline contour of the corresponding openings 4. The bases of the troughs 15 form the deflection zones 13 with their border zones. The push buttons 5 have on all sides a free peripheral area 12, not only from the walls of the holes 4, but also from the walls of the troughs 15.

The previously described casing is manufactured in a multi-component injection moulding process. This is preferably a three-component injection moulding process or a four-component injection moulding process. In a first step in the process the push buttons 5 consisting of a hard plastic material are injected into a forming tool. The forming tool can consist of several parts. It can have a lower, which can be combined with cover tools of various types. Thus, for instance, for producing the push buttons it is possible to employ a first cover tool, which includes a number of individual cavities, each of which corresponds to the shape of the push buttons. The push buttons may also be produced in several injection moulding steps, in particular in two steps. This is necessary if push buttons 5 of diverse colors are to be produced.

After injection of the push buttons, the form tool is varied. This can occur by means of an exchange of the s. It is also possible, however, to provide corresponding slide valve inside the injection moulding tool. In the following injection moulding step, the casing cover 1 is produced. During the exchange of tools or the modification of the tool, however, the push buttons remain in their position. They remain in place with their plungers 9 in the injection moulding form.

The casing covers 1 injected in such a way as to form a recess 11, whose base is structured in cross-bar pattern. In the individual openings 4 of the network, the push buttons are situated at a lateral distance from the wall of the openings 4.

In a final injection moulding step, a soft plastic inset is injected into the recess 11. This occurs in such a way that the border 6′ of the soft plastic inset 6 is connected with the border 11′ of the recess 11 for insulation. This is preferably an adhesion-agent-free adhesion connection. Cementing materials can also be used, or else other adhesion agents. Because the plastic of the cover 1 can still be soft when the soft plastic inset 6 is injected, a melting-type connection can be produced between soft plastic inset 6 and the border of the recess 11.

The borders of the light signal profiles 10 are completely surrounded by injected soft plastic inset 6. An adhesion connection can also exist along with the form-locking anchoring of the light signal profiles 10 in the soft plastic inset 6.

As already described above, the plastic of the push buttons 5 can be of various colors. It can also be of transparent configuration, for instance in order to convey light of a light diode positioned inside toward the outside. In addition it is possible to add phosphorus to the plastic of the push button, so that the light signal profile 10 can be recognized in the dark even without light.

It is also possible to provide that the light signal profiles 10 are of a height greater than the material strength of the soft plastic inset 6. When finished, the light signal profiles 0 then extend beyond the surface of the soft plastic inset 6. The light signal profiles 10 can then be recognized not just optically but also haptically. The arrangement of the correct sensor can than be fulfilled. This facilitates the operation of the keyboard in the dark or in the pocket.

All revealed characteristics are (in themselves) essential to the invention. The publication of this application thus also includes the published content of the related/added priority documents (copy of the preliminary application) in its full extent, which also serves the purpose of incorporating characteristics of these documents in the Claims of the present invention.

1. A casing for a key with sensors that are positioned inside the casing and that are actuated by means of push buttons, so that the push buttons are situated in openings of a casing and can be displaced against a rebound force perpendicularly to the surface of the casing in the direction toward the sensors,
characterized in that the push buttons made of a hard plastic are inserted with a lateral distance in the openings and are held in place by a soft plastic inset inserted into a recess in the casing cover.

2. A casing according to claim 1, characterized in that the push buttons on their underside have plungers for pressure actuation of the sensors.

3. A casing according to claim 1, characterized in that the push buttons on their side facing the plungers bear light signal profiles with which they are held in form-locking connection in the soft plastic inset.

4. A casing according to claim 1, characterized in that the surface of the light signal profiles are flush with the surface of the soft plastic inset.

5. A casing according to claim 1, characterized in that the soft plastic inset is inserted essentially with watertight insulation in the recess.

6. A casing according to claim 1, characterized in that the push buttons and the soft plastic inset are of different colors from one another.

7. A casing according to claim 1, characterized in that the push buttons are made of transparent or phosphorescent material.

8. A casing according to claim 1, characterized by push buttons of diverse colors.

9. Method for producing a casing cover, characterized in that in a first injection moulding step the push buttons are injected on the base of the cavity of a form tool, in a second injection moulding step the casing cover is injected into the same form tool, and in a third process step the soft plastic inset is injected into the same injection moulding form in such a way that its borders are contiguous with the borders of the recess in watertight insulation.

10. A method according to claim 9, characterized in that the push buttons are produced in various colors in several injection moulding steps.

11. A method according to claim 9, characterized in that the soft plastic inset melts together with the recess in certain areas.

12. A method according to claim 9, characterized in that the material strength of the soft plastic inset is lower than the height of the light signal profile.

13. A method according to claim 10, characterized in that the soft plastic inset melts together with the recess in certain areas.

14. A method according to claim 11, characterized in that the material strength of the soft plastic inset is lower than the height of the light signal profile.
